(19) United States
(12) Patent Application Publication
(10) Pub. No.: US 2023/0385982 A1
(43) Pub. Date: Nov. 30, 2023

(54) SPARSE CONVOLUTIONAL NEURAL NETWORK ACCELERATOR FOR 3D/4D POINT-CLOUD IMAGE RECOGNITION

(71) Applicant: Northwestern University, Evanston, IL (US)

(72) Inventors: Jie Gu, Evanston, IL (US); Qiankai Cao, Evanston, IL (US)

(21) Appl. No.: 18/323,285

(22) Filed: May 24, 2023

Related U.S. Application Data
(60) Provisional application No. 63/347,014, filed on May 30, 2022.

(51) Int. Cl. G06T 1/20; G06T 7/73; G06T 7/10

(52) U.S. Cl. CPC G06T 1/20; G06T 7/73; G06T 7/10; G06T 2207/10028; G06T 2207/20021; G06T 2207/20084

(57) ABSTRACT

A sparse convolutional neural network (SCNN) accelerator for 3D and 4D point cloud image recognition and segmentation includes a hopping-index rule book method of coordinate management. The SCNN also utilizes octree data structures for coordinates and a computation skipping method for efficient data search and a compressed weight look-up table for efficient and low-power processing performance.

### CROSS REFERENCE TO RELATED APPLICATIONS

The present application claims the benefit of priority under 35 U.S.C. § 119 from U.S. Provisional Patent Application Ser. No. 63/347,014, entitled “Sparse Convolution Neural Network Accelerator for 3D/4D Point-Cloud Image Recognition,” filed on May 30, 2022, all of which is incorporated herein by reference in its entirety for all purposes.

### STATEMENT OF FEDERALLY FUNDED RESEARCH OR SPONSORSHIP

This invention was made with government support under grant number CCF1846424 awarded by the National Science Foundation. The government has certain rights in the invention.

### TECHNICAL FIELD

The present disclosure generally relates to neural network accelerators, and more specifically relates to sparse convolutional neural network accelerator for 3D/4D point-cloud image recognition.

### BACKGROUND

Virtual reality (VR) is a simulated experience in which a computer-generated environment is presented to a user in response to and based on position and/or motion information obtained about the user by the computer. A user typically wears a headset that tracks movement and orientation of the user's head while displaying the computer-generated environment to the user. The displayed computer-generated environment is typically continuously updated by the computer based on the tracked movement and orientation of the user's head so that the user enjoys an immersive experience in a virtual world generated by the computer.

Augmented reality (AR) is an interactive experience that combines computer-generated virtual elements with a user's perceptions of the real world. Typically, a user views the real-world environment surrounding the user through a camera and display, such as on a cell phone or through a headset that includes a video display and a camera. The computer superimposes the computer-generated virtual elements onto the video display by determining coordinates of real-world objects in the display and a relative position of the user, and then mapping the desired coordinates of the virtual elements onto the coordinates of the real-world objects in the display. The cell phone or headset track its respective movement and orientation while displaying the real-world environment, and the displayed computer-generated virtual elements are typically continuously updated by the computer based on the tracked movement and orientation in order to appropriately maintain the virtual elements' relative position, orientation, and size compared to the real-world environment over which they are superimposed in the video display.

A point cloud is a discrete set of data points in space. Points in a point cloud are typically represented with three numbers for 3D space (e.g., cartesian coordinates x, y, z). 4D point clouds for videos are typically represented with four numbers for 3D space plus time (e.g., cartesian coordinates x, y, z, plus time t). A point cloud may be generated from image data to represent relative positions of real-world objects. A point cloud may be generated to represent relative positions of VR objects. The real-world and VR point clouds may be registered to or mapped onto each other in order to track and maintain the positions of VR objects relative to real-world objects in an AR environment.

A convolutional neural network (CNN) is a type of artificial neural network (ANN) that applies the mathematical convolution operation in at least one of its layers. CNNs are typically applied to analyze images. For example, they may be specifically designed to process image pixel data in image recognition and processing applications.

The description provided in the background section should not be assumed to be prior art merely because it is mentioned in or associated with the background section. The background section may include information that describes one or more aspects of the subject technology.

### SUMMARY

An exemplary method for processing sparse point clouds using a sparse convolutional neural network (SCNN) includes configuring a processing element (PE) array for performing multiply-accumulate (MAC) operations for coordinate management. A plurality of input sparse point cloud data including spatial coordinate data and an end address are stored in an input memory. The plurality of input sparse point cloud data are loaded into the PE array. The end address is loaded in an index memory. Multiple weights of different outputs for the same input are loaded into the index memory. Multiple weights from a kernel weight look-up table (LUT) are loaded into the PE array. The weights are loaded based on an index value of the index memory. The index value is shared by a plurality of output channels of the PE array. Outputs of MAC operations by the PE array are accumulated into output memory based on a target output address memory stored in the index memory.

The method may also include configuring the PE array for performing sparse convolutional neural network processing. The method may also include storing, in the input memory, a plurality of input sparse point cloud data including pixel value data. The method may also include performing image segmentation using sparse convolution on the plurality of input sparse point cloud data including pixel value data in the PE array. The method may also include outputting the image segmentation data based on the target output address memory stored in the index array.

The method may also include calculating a distance, by the PE array, between a pair of coordinates of the input sparse point cloud data. The method may also include determining that the distance is less than a neighbor threshold distance. Responsive to determining that the distance is less than the neighbor threshold distance, the method may include writing a relative position of the pair of coordinates into a rule book.

The method may also include calculating a distance, by the PE array, between a respective position along one axis of each of a pair of coordinates of the input sparse point cloud data. The method may also include determining that the distance is greater than a neighbor threshold distance. Responsive to determining that the distance is greater than the neighbor threshold distance, the method may include refraining from calculating further distances between respective positions along other axes of the pair of coordinates. Responsive to determining that the distance is greater than the neighbor threshold distance, the method may also include refraining from writing relative position information of the pair of coordinates into the rule book.

The method may also include dividing the input sparse point cloud into sub-space according to an octree data structure for searching, and searching for a pair of coordinates of the input sparse point cloud data within a sub-space block. The method may also include determining that one of the pair of coordinates being searched is within a different sub-space block, and increasing a size of a sub-space block to encompass both of the pair of coordinates being searched.

The method may also include dividing the input sparse point cloud into sub-space according to an octree data structure for searching, searching for a pair of coordinates of the input sparse point cloud data within a sub-space block, and determining that the pair of coordinates being searched are too distant to be neighbors based on the search within the sub-space block. Responsive to determining that the pair of coordinates being searched are too distant to be neighbors, the method may also include discontinuing the search for the pair of coordinates in the input sparse point cloud.

An exemplary non-transitory computer readable medium stores computer-readable instructions executable by a hardware computing processor to perform operations of a method for processing sparse point clouds using a SCNN as described herein.

An exemplary system for processing sparse point clouds using a SCNN includes at least one device including a hardware computing processor, the system being configured to perform operations of a method for processing sparse point clouds using a SCNN as described herein. The system may include a non-transitory memory having stored thereon computing instructions, executable by the hardware computing processor, to perform operations of a method for processing sparse point clouds using a SCNN as described herein.

An exemplary system for processing sparse point clouds using a SCNN includes at least one device including a hardware circuit operable to perform a function, the system being configured to perform operations of a method for processing sparse point clouds using a SCNN as described herein.

### BRIEF DESCRIPTION OF DRAWINGS

The disclosure is better understood with reference to the following drawings and description. The elements in the figures are not necessarily to scale, emphasis instead being placed upon illustrating the principles of the disclosure. Moreover, in the figures, like-referenced numerals may designate to corresponding parts throughout the different views.

FIG. 1 is a conceptual graphic that illustrates some aspects of an exemplary SCNN as disclosed herein.

FIG. 2 is a conceptual graphic that illustrates an exemplary Minkowski-type sparse convolutional neural network (SCNN) for segmenting a sparse 3D/4D point cloud.

FIG. 3 is a graphic illustration that shows an exemplary top-level chip architecture for a 3D/4D SCNN.

FIG. 4 is a graphic illustration that shows an exemplary 3D/4D point cloud processing sequence 400 using the SCNN, with a timeline advancing from the left to the right.

FIG. 5A is a graphic illustration of an exemplary architecture and process flow of a SCNN including a “hopping-index rule book” (HIRB) process that may map sparse input pixel data points to corresponding output pixel data points.

FIG. 5B is a conceptual graphic that illustrates an exemplary kernel index memory being used in conjunction with a look-up table (LUT) storing address information.

FIG. 5C is a conceptual graphic that illustrates an exemplary weight look-up table (LUT) being used to place the weights used by the PE array in the appropriate channels and during the appropriate cycles of operation of the PE array.

FIG. 6 is a conceptual graphic to further illustrate a “hopping-index rule book” (HIRB) process that may map sparse input pixel data points 605 to corresponding output pixel data points using a kernel index memory.

FIG. 7A is a graphic illustration of an exemplary architecture and process flow of a SCNN including a 4D coordinate memory that show implementation of an exemplary coordinate management scheme for generation of the HIRE for building spatial/temporal relationships among sparse point cloud data points.

FIG. 7B is a conceptual graphic to further illustrate exemplary coordinate management.

FIG. 8 is a flow chart that illustrates an exemplary process of building an HIRB in a SCNN using a coordinate management strategy.

FIG. 9A is a conceptual graphic that illustrates architecture of an octree data structure.

FIG. 9B is a flow chart that illustrates an exemplary coordinate data skipping workflow.

FIG. 9C is a conceptual graphic of a sparse point cloud that illustrates architecture and operations of an octree data structure and coordinate skipping workflow described earlier.

FIG. 9D is a flow chart that illustrates an exemplary process of performing a coordinate skipping octree data structure search for coordinate memory management.

FIG. 10 is an annotated photograph of an exemplary fabricated SCNN accelerator test chip according to the present disclosure.

FIG. 11 shows graphics and a data table that illustrate examples of 3D segmentation results from a 3D point cloud ground truth and corresponding mIOU scores for the 3D point cloud images.

FIG. 12 shows graphics and a data table that illustrate examples of 4D segmentation results from a 4D point cloud input and corresponding mIOU scores for the 4D point cloud images.

FIG. 13A shows a graph that illustrates the accuracy of this work on database SCANNET for 3D quantization with only 0.1% accuracy loss compared with FP results.

FIG. 13B shows a graph that illustrates the accuracy of this work on database SYNTHIA for 4D quantization with only 0.1% accuracy loss compared with FP results.

FIG. 14 is a table that shows comparisons of the measurements of the test chip with prior point-cloud works.

FIG. 15 is a graph that shows the run time reductions of the SCNN test chip compared to dense CNN examples for 3D point clouds and 4D point clouds.

FIG. 16 is a graph that shows how voltage scaling from 0.5 V to 1.2 V affects both frequency and power.

FIG. 17 is a graph that shows how voltage scaling from 0.5 V to 1.2 V affects power efficiency without image sparsity.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The disclosed technology provides a sparse convolutional neural network (SCNN) for point cloud image recognition on low-power devices. The disclosed technology also provides a special hopping-index rule book method and efficient data search technique to mitigate coordinate management overhead for a SCNN. The disclosed technology was demonstrated via a 65 nm technology integrated circuit (IC) test chip for 3D/4D image applications. The test chip demonstrated 7.09-13.6 tera-operations/second/Watt (TOPS/W) power efficiency and state-of-the-art frame rate. The SCNN accelerator for 3D/4D point-cloud image applications provides a speedup over conventional dense CNN of 89.3× for 3D and 270.1× for 4D. The efficient hopping index rule book (HIRB) generation flow provides a 12× speedup for coordinate management. Neural network weight value storage was reduced with index and look-up table (LUT)-based weight re-use scheme, reducing weight duplications and resulting in a memory savings of 13.5×˜29.6×. The test chip also demonstrated 7.5× higher normalized framerate than prior point-cloud design.

Compared with two-dimensional (2D) cases, three-dimensional (3D) and four-dimensional (4D) applications experience exponential increases of computational workload while data sparsity dramatically increases (e.g., 97.5% in 3D, 99.9% in 4D). Use of a sparse CNN (SCNN) instead of a dense CNN may greatly reduce computational workload in 3D and 4D applications. However, there may be significant overhead involved in index/coordinates management in SCNNs for a sparse input format. If the overhead is assumed to be 40%, then SCNNs may begin to have superior performance compared to dense CNNs when the level of sparsity reaches a point between 20% and 40%, and the degree of superiority in performance may continue to grow for sparsity levels above that. As an example, if the level of sparsity in a 3D/4D point cloud is 30% and the overhead for index/coordinates management in the SCNN for a sparse input format is 40%, an SCNN may perform better than a CNN for processing the 3D/4D point cloud, e.g., for 3D/4D point cloud image recognition. Fundamentally, SCNN provides a more efficient solution than dense CNN for high dimensional sparse images.

In the following disclosure, a 3D/4D SCNN accelerator architecture and process flow based on the Minkowski engine are described. Experimental results from a silicon application specific integrated circuit (ASIC) implementing this 3D/4D SCNN accelerator architecture that was fabricated and tested are also presented. A hardware-friendly “rule book” solution for managing coordinates of sparse 3D/4D image data in SCNNs is also described. The “rule book” solution lead to a speedup of 89.3× for 3D and 270.1× for 4D SDNNs compared to conventional dense CNNs. A hardware-efficient coordinate generation and search solution utilizing an octree data structure and a computation-skipping method, implemented to achieve a 12× speedup enhancing the benefits of sparse convolution, is also described. Also described is a look-up table (LUT)-based weight re-use scheme utilized to reduce weight duplications in memory which led to a 26.9× savings of memory space.

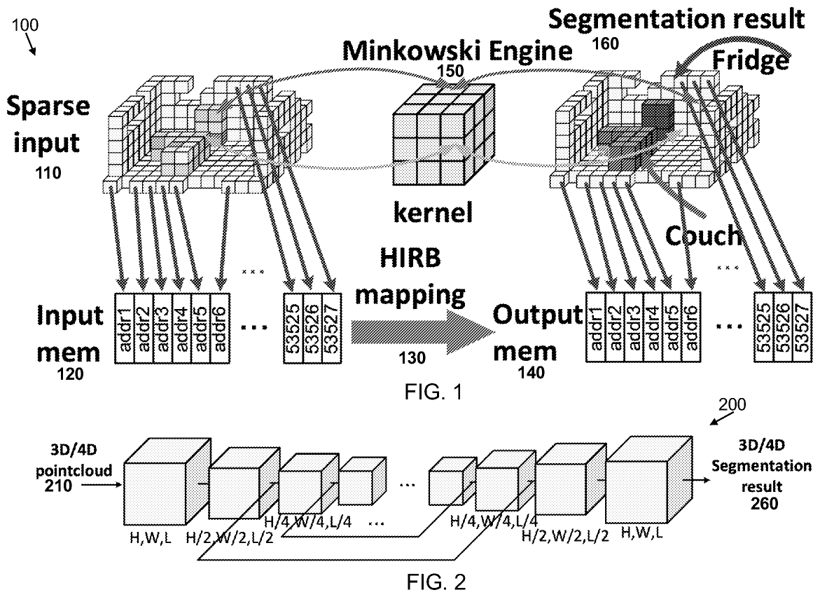

FIG. 1 is a conceptual graphic that illustrates some aspects of an exemplary SCNN as disclosed herein. A sparse input 110 (e.g., a sparse 3D point cloud) may be input into a SCNN having an input memory 120, where the pixel data of the sparse input 110 may be stored in particular corresponding input memory addresses. An SCNN kernel based on a Minkowski engine 150 may process the sparse input 110 to generate a segmentation result 160 that recognizes objects within the sparse input 110, such as a fridge and a couch, for storing and later use. An efficient hardware-friendly “hopping-index rule book” (HIRB) mapping 130 may map memory addresses of the pixel data of the sparse input 110 to corresponding memory addresses of an output memory 140 where corresponding pixel data of a segmentation result 160 may be stored.

FIG. 2 is a conceptual graphic that illustrates an exemplary Minkowski-type sparse convolutional neural network (SCNN) 200 for segmenting a sparse 3D/4D point cloud. A 3D or 4D point cloud dataset 210 having a height H, width W, and length L (and also time duration T for a 4D point cloud, not shown in FIG. 2) may be input into the Minkowski-type SCNN 200. The Minkowski-type SCNN 200 may output a 3D/4D segmentation result 260. The Minkowski-type SCNN 200 may perform a generalized sparse convolution process for all dimensions of the input 3D or 4D point cloud dataset 210. The Minkowski-type SCNN 200 may perform submanifold convolution to maintain sparsity of the point cloud to avoid a dilation effect, which may otherwise significantly increase the amount of data points of the point cloud after the convolution is performed.

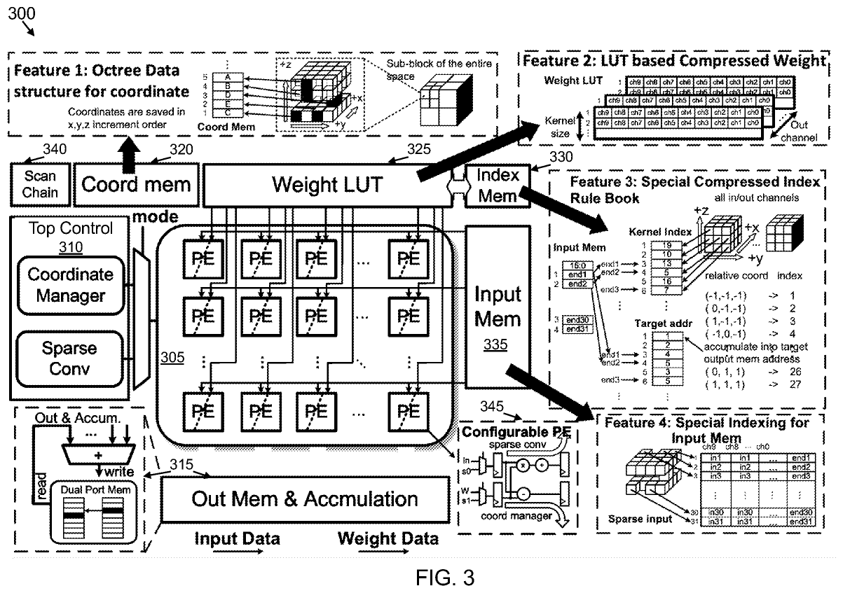

FIG. 3 is a graphic illustration that shows an exemplary top-level chip architecture for a 3D/4D SCNN 300. The SCNN 300 includes 10×10 processing element (PE) array 305 as a central compute engine. In various examples, different quantities of PEs may be included in the PE array such that the dimensions and processing capabilities of the PE array may be different than in the example including the 10×10 PE array 305. The SCNN 300 also includes a top controller 310 for data flow management. The top controller 310 includes a coordinate manager module to control the PE array 305 to operate in a coordinates manager mode, and a sparse convolution control module to control the PE array 305 to operate in a sparse convolution mode. The SCNN 300 also includes output memory & accumulation modules 315 and other memory and post processing modules for SCNN. The SCNN 300 also includes various memory banks with special indexing schemes to support the rule book and SCNN operations, which will be identified and discussed in greater detail below. For example, a coordinate memory bank 320 may be used in octree data structure-based coordinates storage and search operations (Feature 1). A weight look-up table (LUT) 325 may be used in a LUT-based compress weight storage strategy (Feature 2). An index memory 330 may be used in a special compressed index rule book strategy (Feature 3). An input memory bank 335 may be used in a special indexing strategy for input memory (Feature 4). The PEs of the PE array 305 may be configurable into two different modes at different times: a sparse convolution mode when the top controller 310 sets the PE array 305 into a sparse convolution mode, and a coordinates manager mode when the top controller 310 sets the PE array 305 into a coordinates manager mode. The SCNN 300 may include a scan chain 340 for performing testing of the SCNN 300 integrated circuit after manufacturing.

The SCNN 300 may define a rule book as pairs of input and output coordinates, for example, to map the input non-zero pixel coordinate data points from a point cloud to output non-zero pixel coordinate data points. The rule book may reduce computational complexity of performing management of the coordinates of non-zero pixel data of the point cloud and the relationships between the non-zero pixel data points when performing sparse convolution by not building, rebuilding, or storing such relationships between non-zero pixel data points that are not neighbors. The rule book may be illustrated by Eq. 1:

M={(Iᵢ,Oᵢ)}ᵢ for i∈N^{D} (1)

where M represents the rule book map of input pixel coordinate data points to output pixel coordinate data points, I represents the set of input pixel coordinate data points, O represents the set of output pixel coordinate data points, i represents the index value of the particular pairing of input to output pixel coordinate data points, N is the quantity of non-zero pixel data elements, and D is the dimension of the space (e.g., 3 or 4).

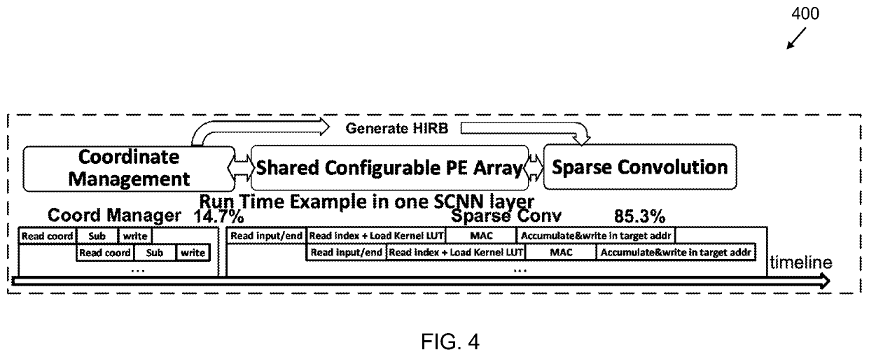

FIG. 4 is a graphic illustration that shows an exemplary 3D/4D point cloud processing sequence 400 using the SCNN 300, with a timeline advancing from the left to the right. Coordinate management is performed by a coordinates manager for rule book generation, e.g., the efficient hardware friendly “hopping-index rule book” (HIRB) mapping 130. Operations performed by the coordinates manager in a run-time example in one SCNN layer include, in an order of top to bottom and left to right in the timeline: read coordinates, subsample data, read coordinates, write coordinates, subsample data, write coordinates, etc. Operations performed during the sparse convolution in a run-time example in one SCNN layer include, in an order of top to bottom and left to right in the timeline: read input/end data, read index+load kernel look-up table, read input/end, read index+Load Kernel look-up table, read index+Load Kernel look-up table, multiply-accumulate, accumulate & write in target address, multiply-accumulate, accumulate & write in target address. The SCNN 300 may divide input point cloud images into sub-spaces for processing by the SCNN 300 chip. The PE array 305 may be an 8-bit reconfigurable PE array designed to support both coordinate management and SCNN for a compact chip implementation.

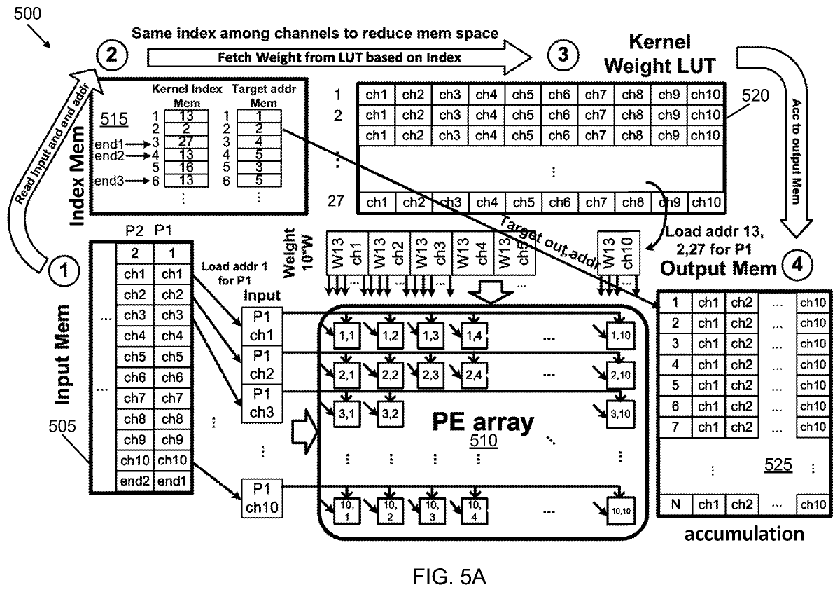

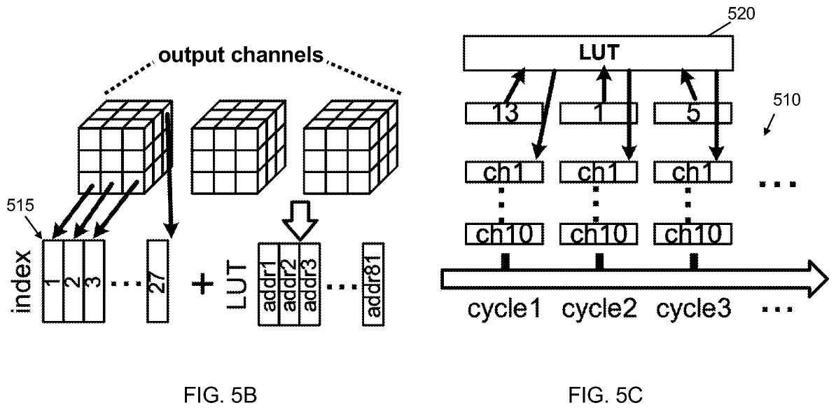

FIG. 5A is a graphic illustration of an exemplary architecture and process flow of a SCNN 500 including a “hopping-index rule book” (HIRB) process that may map sparse input pixel data points to corresponding output pixel data points. FIG. 5B is a conceptual graphic that illustrates an exemplary kernel index memory 515 being used in conjunction with a look-up table (LUT) storing address information. FIG. 5C is a conceptual graphic that illustrates an exemplary weight look-up table (LUT) 520 being used to place the weights used by the PE array 510 in the appropriate channels and during the appropriate cycles of operation of the PE array 510. The combination of the kernel index memory 515 and the LUT 520 provide reduced weight storage with index and look-up table. A same index may be used among the channels to reduce memory space.

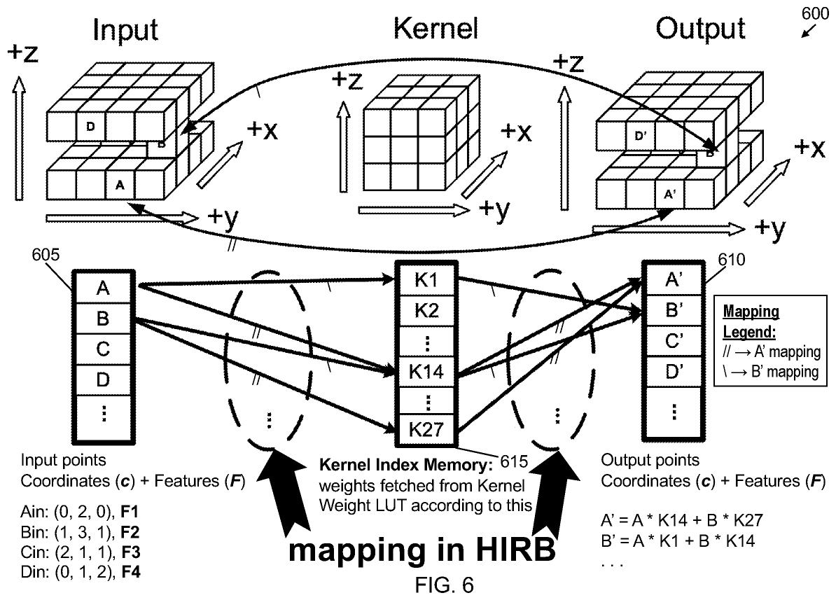

FIG. 6 is a conceptual graphic 600 to further illustrate a “hopping-index rule book” (HIRB) process that may map sparse input pixel data points 605 to corresponding output pixel data points 610 using a kernel index memory 615. A sparse tensor may be used because only non-zero points may be stored and processed in a sparse convolutional neural network (SCNN). The sparse tensor may include both coordinate c and feature F, and be represented as follows:

$$c = ( \begin{matrix}{x}_{1}^{1} & … & {x}_{1}^{D} \\ ⋮ & ⋱ & ⋮ \\ {x}_{N}^{1} & … & {x}_{N}^{D}\end{matrix} ) \qquad ( 2 )$$

$$F = ( \begin{matrix}{f}_{1}^{T} \\ ⋮ \\ {f}_{N}^{T}\end{matrix} ) \qquad ( 3 )$$

where N is the number of non-zero elements, and D is the dimension of the space (e.g., 3 or 4). The feature F may include R, G, B values for an image pixel. Another way to represent the sparse tensor may be as follows:

$$T [ {x}_{i}^{1} , {x}_{i}^{2} , {x}_{i}^{3} , … , {x}_{i}^{D} ] = \{ \begin{matrix}{f}_{i} , & if ( {x}_{i}^{1} , {x}_{i}^{2} , {x}_{i}^{3} , … , {x}_{i}^{D} ) ∈ C \\ 0 , & otherwise\end{matrix} \qquad ( 4 )$$

For 3D/4D SCNN, input pixels with non-zero values may be stored in an input memory module 505 with coordinates (x, y, z, t) associated with feature values, eliminating the large quantities of redundant zeros in the 3D/4D space. In SCNN mode, the sparse inputs stored in the input memory module 505 are fed into the PE array 510 column by column, while kernel weights from a kernel weight look-up table (LUT) 520 are fed into the PE array 510 row by row. The PE array 510 is configured to perform MAC operations processing sparse inputs from the input memory 505 and kernel weight values from the kernel weight LUT 520. A special map representing coordinate relationships between pixels may be built to compensate for the loss of spatial relationships between pixels in sparse coding. Such a special map may be referred to as a “rule book” herein. Software implementations of such a rule book using hash functions may not be suitable for a small-size ASIC SCNN accelerator due to the overwhelming memory operations for keyword search and high computation cost of hash functions that such implementations would entail.

Therefore, described herein is a new efficient hardware-friendly “hopping-index rule book” (HIRB) methodology and SCNN system architecture that features multiple hopping of memory banks through the use of data indexes. Major sequential operations of the HIRB methodology and associated SCNN components are shown in FIG. 5. First, input and an end-address (e.g., the contents of column P1 in the input memory 505) may be read. In other words, a column (e.g., P1) of sparse inputs stored in the input memory 505 may be loaded into PE array 510 configured for MAC operation, while the last 16-bits “end” address is sent to index memory 515 to provide the stop address for current input. In an example, this input and end-address may correspond to the input point A shown in the input memory 605.

Second, the core index memory 515 may perform loading of multiple weights of different outputs for the same input until the stop address (i.e., “end” address) is reached. A new index may load into the kernel index memory of index memory 515 when the kernel index counts to the end address. As illustrated in FIG. 5A, the kernel index memory may be loaded with 13, 2, and 27 for the input in the P1 column of the input memory 505. In an example as illustrated in FIG. 6, the kernel index memory 615 may load a new index when the kernel index counts to the end address.

Third, a weight may be fetched according to the kernel index. The index may be shared by all output channels. As illustrated in FIG. 5A, weights from the LUT corresponding to addresses 13, 2, and 27 (stored in kernel index memory elements 1, 2, and 3) may be loaded into the row of weight registers above and feeding weight data into the PE array 510. In an example as illustrated in FIG. 6, three weights K2, . . . , K27 in the kernel index memory 615 may be fetched. For MAC operation, to fetch the weight value accordingly, instead of duplicating the channel-wise weights, an 8-bit index indicating mapping between kernel and input shared by all channels may be used so that weights stored in kernel weight LUT 520 are fetched according to kernel index, rendering 13.5×˜26.9× memory savings varying with channel number.

Fourth, the MAC operations of the PE array 510 may accumulate into the output memory 525 based on the target output address pointer stored in the target address memory of the index memory 515. As illustrated in FIG. 5A, target output addresses 1, 2, 4 are designated for input memory column P1 that was stored in the index memory 515. In an example as illustrated in FIG. 6, the target output address pointers indicated in the target address memory of the index memory 515 define which addresses of the output memory 610 are used to store the results of the MAC operations. The multiple MAC outputs from the same input point may be stored into different target addresses of output memory 525 according to the target output address memory stored in the index memory 515. This data flow illustrated in FIG. 5 and described herein not only provides a solution for irregular sparse convolution data mapping, but also provides a general SCNN solution for variable dimensions, 2D/3D/4D and beyond.

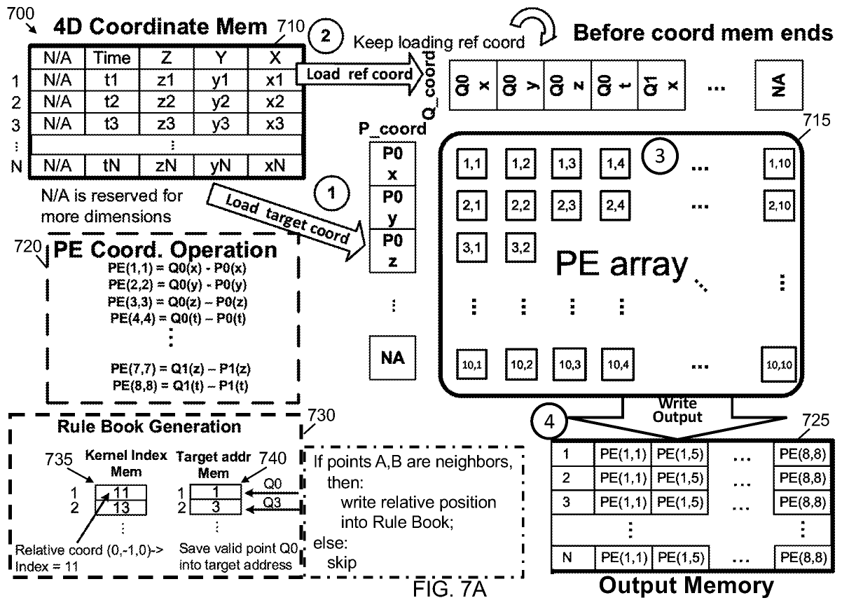

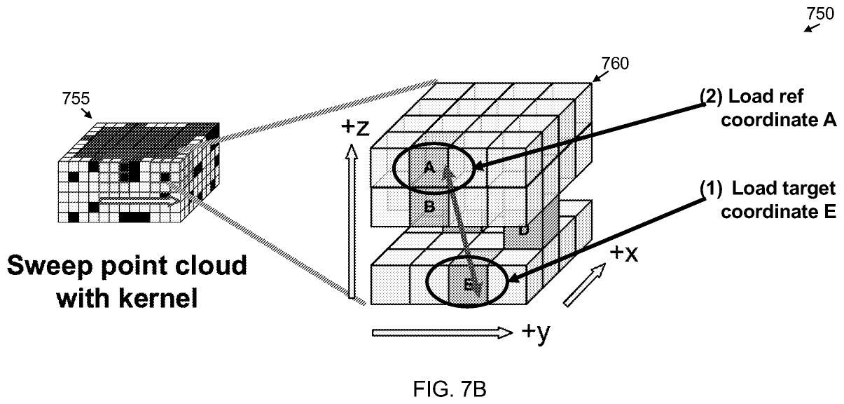

FIG. 7A is a graphic illustration of an exemplary architecture and process flow of a SCNN 700 including a 4D coordinate memory 710 that show implementation of an exemplary coordinate management scheme for generation of the HIRE for building spatial/temporal relationships among sparse point cloud data points. FIG. 7B is a conceptual graphic 750 to further illustrate exemplary coordinate management. Target coordinates are referred to in FIG. 7A as beginning with the letter “P” while reference coordinates are referred to as beginning with the letter “Q”. A coordinate operation may be graphically illustrated in FIG. 7B, which illustrates a sparse point cloud 755 being swept over all dimensions with the kernel of the SCNN 700. A subset of the sparse point cloud 755 located in its front upper right corner is illustrated in greater detail as sparse subcloud 760. Coordinate management may include loading target coordinates and loading reference coordinates.

First, target coordinates may be loaded from the coordinates memory 710 into P_coord registers vertically arranged to the left of a PE array 715. For example, a target coordinate E as indicated in the sparse subcloud 760 may be loaded into P_coord registers. For example, 4D target coordinate P0=(x0, y0, z0, t0).

Second, reference coordinates may be loaded from the coordinates memory 710 into Q_coord registers horizontally arranged above the PE array 715. For example, a reference coordinate A as indicated in the sparse subcloud 760 may be loaded into Q_coord registers. For example, 4D reference coordinates Q0=(x1, y1, z1, t1), Q1=(x2, y2, z2, t2). The reference coordinates may continue to be repeatedly loaded before the coordinates memory ends.

Third, the PE array 715 may perform coordinate management computations. These computations may be SUB or subtraction operations, performed while the PE array 715 is set in a coordinates management mode by the top control 310. The coordinate management computations performed by the PE array 715 may be represented by a set of PE coordinate operation equations 720, in which a difference between reference coordinates Q and target coordinates P are calculated. Distance information between 3D/4D points may be calculated by the PE array 715 configured in coordinate management mode. For example, 4D distances d0=(x1-x0, y1-y0, z1-z0, t1-t0)=(0, −1, 0, 0), neighbor=yes; d1=(x2-x0, y2-y0, z2-z0, t2-t0)=(0, −2, −2, 0), neighbor=no.

Fourth, the output of the PE array 715 following the coordinate management computations may be written to an output memory 725. According to the PE coordinate operation equations 720, the output memory 725 may include the distances between pairs of reference coordinates and target coordinates. A pair of reference coordinates and target coordinates may be considered neighbors if the distance between them is less than a neighbor threshold distance.

A rule book generation process may sweep through the sparse point cloud 755, and if two points A and B are neighbors (e.g., computations performed by the PE array 715 determined that they are closer to each other than a threshold neighbor distance), then a relative position of the target coordinate (e.g., relative to the reference coordinate Q) may be written into the kernel index memory 735 while a valid coordinate for the reference coordinate may be written into the target memory 740. No relative position information may be written into the rule book if the coordinate points are not neighbors.

Based on the distance information calculated by the PE array 715 and written to the output memory 725, relative positions between neighbors may be written into kernel index memory 735 in a rule book generation process 730. Corresponding valid reference coordinates may be saved in the target address memory 740. Thus, pairs of coordinate points having a distance between them that is lower than a threshold neighbor distance may be recorded as neighbors in the rule book (e.g., HIRB), but corresponding data for other pairs of coordinate points that are further from each other may not be recorded in the HIRE.

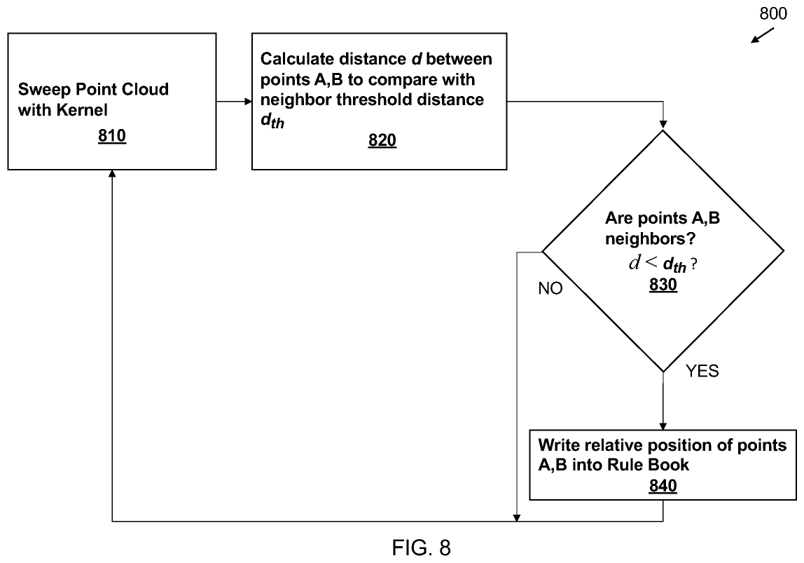

FIG. 8 is a flow chart that illustrates an exemplary process 800 of building an HIRB in a SCNN using a coordinate management strategy. In an operation 810, a sparse point cloud (e.g., point cloud 755) may be swept across all coordinates with a kernel of the SCNN to identify and begin processing all pairs of points in the sparse point cloud. The sweep may be across x, y, z, and/or t. For each pair of data points considered during the sweeping, operation 820 may be called to begin processing the pair of data points. The sweeping and processing may begin at a coordinate point of all zeros, and sweeping may continue until all pairs of data points in the sparse point cloud have been considered and processed by the process 800.

An operation 820 may calculate a distance d between points A and B, so that the distance d may be compared with a neighbor threshold distance dₜₕ. In an operation 830, a determination may be made that points A and B are neighbors if an equation d<dₜₕ is true. If points A and B are neighbors, a relative position of the points A and B may be written into the Rule Book in an operation 840. Otherwise, if the equation is false, nothing may be written into the Rule Book for the current pair of points and the parameter sweeping may continue at operation 810.

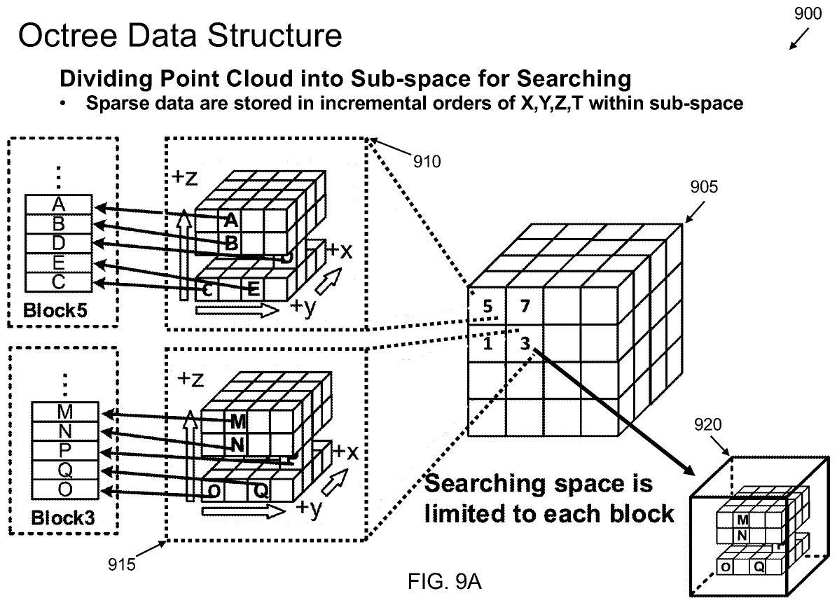

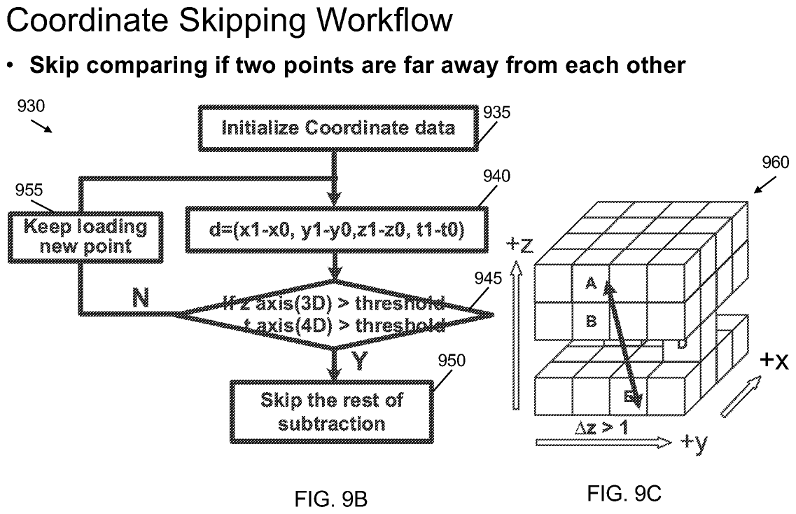

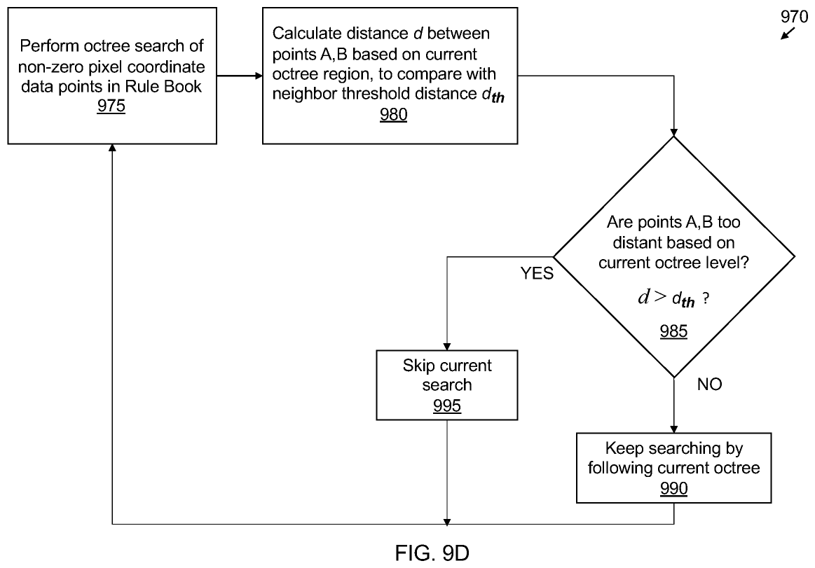

FIG. 9A is a conceptual graphic that illustrates architecture of an octree data structure 900. Because a brute-force sequential search may incur a high computational cost, an octree data structure and a data skipping (e.g., coordinate skipping) technique described with reference to FIG. 9B may be utilized to accelerate the operations of the SCNN 700, for example by reducing data storage requirements and computational processing requirements. With entire space divided into subspace from the octree data structure 900 and the sparse data stored in incremental orders of X, Y, Z, T, neighborhood searching may be significantly narrowed. Moreover, partial distances in Z axis or T axis may be calculated first and skipped if the partial distance is determined to be larger than a threshold. Overall, the use of octree data structure and distance skipping may lead to a 12× savings on computing costs, thereby reducing coordinate management overhead from 67.5% to 14.7% of total operations, further enhancing the benefits of the SCNN described herein.

As is shown in FIG. 9A, a point cloud 905 may represent an entire search space divided into sub-spaces 910, 915, etc. Searching may be performed in the sub-spaces 910, 915, etc. to reduce computational complexity, resources, and time required for performing the searches. A dimensional size of the sub-space may be set based on various factors and may be variable. The search of a sub-space is limited to the sub-space block. If during a search of a sub-space, it is determined that the search should continue to another block, then a larger sub-space may be included while the search continues. When a rule book is generated that crosses sub-space block boundaries, a larger sub-space 920 may be included than the original sub-space size for generating the rule book.

FIG. 9B is a flow chart that illustrates an exemplary coordinate data skipping workflow 930. Skipping subtraction and/or comparison operations when the operations already performed for a pair of data points is determinative as to the comparison results, e.g., whether a pair of data points are not neighbors, may reduce computations, time, and power expended. For example, point cloud points may be stored in an order of coordinate increment, e.g., x, y, z, t. If computations and comparisons of the z axis coordinate determine that two points in the point cloud are not neighbors, no results of computations of the other axes will change the end result that the two points are not neighbors. Therefore, the additional computations and comparisons of the other axes need not be made and may be skipped. Power usage may be saved by 1.8× by using the coordinate skipping workflow.

In an operation 935, coordinate data is initialized, for example, for a pair of coordinate points in a sparse point cloud, such as any two of A, B, D, or E in FIG. 9C. In an operation 940, a distance d between a pair of coordinate points initialized in operation 935 is calculated. In an operation 945, partial distances based on the computations performed in the octree search process so far are compared to a distance threshold dₜₕ. If the partial distance is greater than the distance threshold, then the octree search can be terminated and no further subtraction operations need to be performed (operation 950) because the end result cannot turn out to be less than the distance threshold. If the partial distance is not greater than the distance threshold, the octree search may continue at operation 955 by continuing to load new coordinate points and proceed to operation 940 from there.

FIG. 9C is a conceptual graphic of a sparse point cloud 960 that illustrates architecture and operations of an octree data structure 900 and coordinate skipping workflow 930 described earlier. As shown in the sparse point cloud 960, the differences between 3D coordinates of the pair A,B of coordinate points may be calculated as follows: A-B=(0,0,1) in operation 940. If the distance threshold dₜₕ is set to be (1,1,1), then A-B<(1,1,1), and the computation of the z_axis(3D) is <threshold as determined in operation 945. Thus, the process 930 may continue loading new data points at operation 955. However, the differences between 3D coordinates of the pair A,E of coordinate points may be calculated as follows: A-E=(0,−1,2) in operation 940. If the distance threshold dₜₕ is set to be (1,1,1), then A-E>(1,1,1), and the computation of the z_axis(3D) is >threshold as determined in operation 945. Thus, the process 930 may skip the rest of subtraction in operation 950 as A and E have already been determined to not qualify as neighbors, even before their full coordinates have been subtracted from each other in all dimensions of the point cloud. This is a computation-saving measure, as point cloud coordinate points may be stored in an order of coordinate increments (e.g., x, y, z). Therefore, if computing the z-axis distance alone shows that the two coordinate points are not eligible as neighbors, then computing the other axis distances is unnecessary.

FIG. 9D is a flow chart that illustrates an exemplary process 970 of performing a coordinate skipping octree data structure search for coordinate memory management. In an operation 975, an octree search of non-zero pixel coordinate data points in an octree data structure representing a sparse point cloud is performed to find a pair of coordinate data points A, B. In an operation 980, a distance d between points A and B is calculated based on the current octree region, so that the distance d may be compared with a neighbor threshold distance dₜₕ. In an operation 985, a determination may be made that points A and B are too distant from each other to continue the search if an equation d>dₜₕ is true. If points A and B are too distant, the current search is skipped at operation 995, but a new search may then begin at operation 975 if desired. Otherwise, if the points A and B are determined to not be too distant from each other in operation 985, at operation 990 the current octree search may be caused to continue at operation 975.

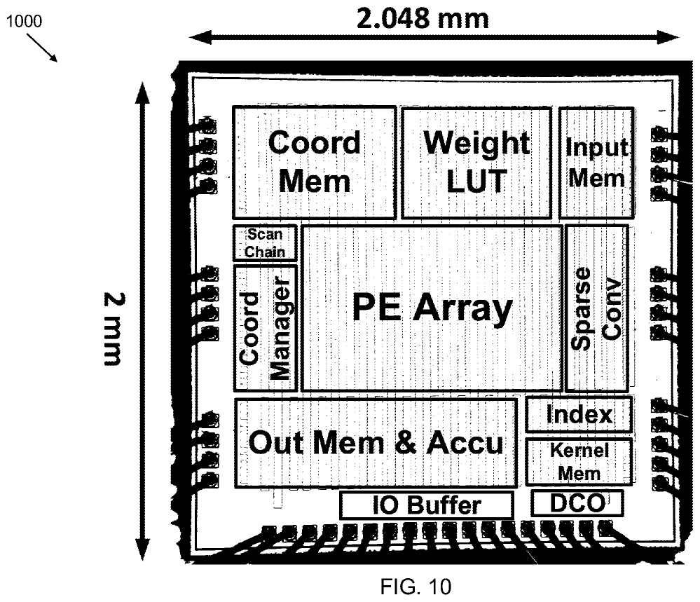

FIG. 10 is an annotated photograph of an exemplary fabricated SCNN accelerator test chip 1000 according to the present disclosure. The test chip 1000 includes component sections identified in FIG. 10 that correspond to those illustrated in the diagram of FIG. 3. These component sections include coordinates memory, weight LUT, input memory, scan chain, coordinates manager, PE array, sparse convolution module, output memory and accumulator, index, kernel memory, I/O buffer, and digitally controlled oscillator (DCO). The test chip 1000 was fabricated in a 65 nm fabrication process. The test chip 1000 operates from the nominal 300 MHz/1V to 50 MHz/0.5V with efficiency from 0.78 TOPS/W to 1.5 TOPS/W without considering sparsity or 7.09 TOPS/W to 13.6 TOPS/W considering sparsity for 8-bit SCNN. The coordinate management takes 14.7% of runtime consuming 35% less power than SCNN.

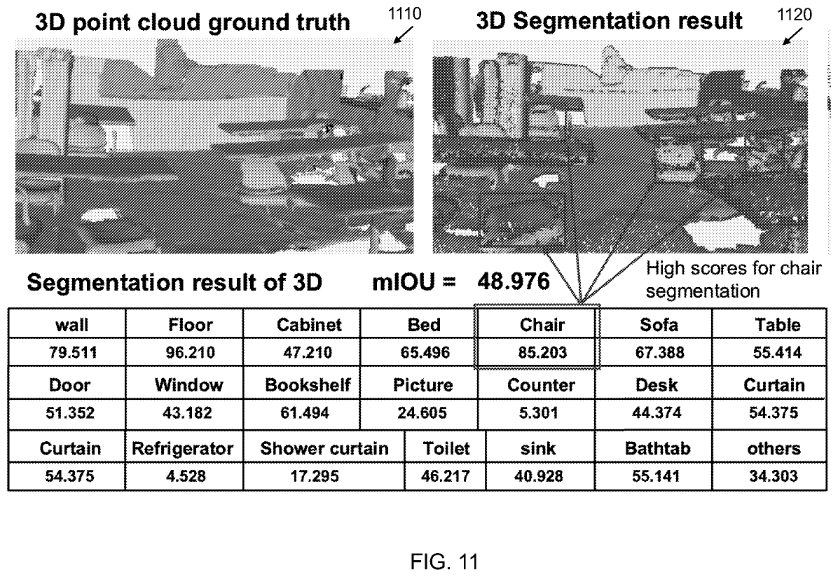

FIG. 11 shows graphics and a data table that illustrate examples of 3D segmentation results 1120 from a 3D point cloud ground truth 1110 and corresponding mIOU scores for the 3D point cloud images. FIG. 11 shows that high scores were achieved for chair segmentation in the 3D segmentation result 1120.

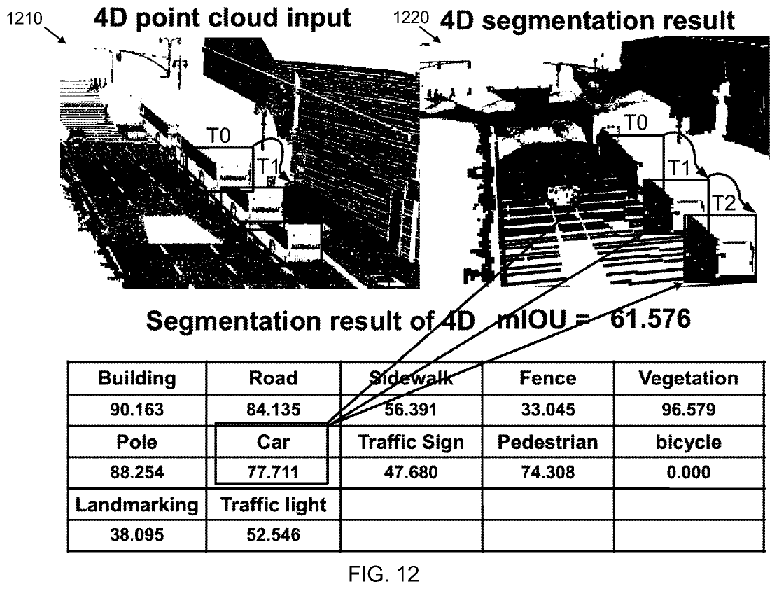

FIG. 12 shows graphics and a data table that illustrate examples of 4D segmentation results 1220 from a 4D point cloud input 1210 and corresponding mIOU scores for the 4D point cloud images. FIG. 12 shows that good scores were achieved for car segmentation in the 4D segmentation result 1220 and that the segmentation for the car was achieved at time points T0, T1, and T2, as the car was at a different location in the 4D point cloud images at these different time points.

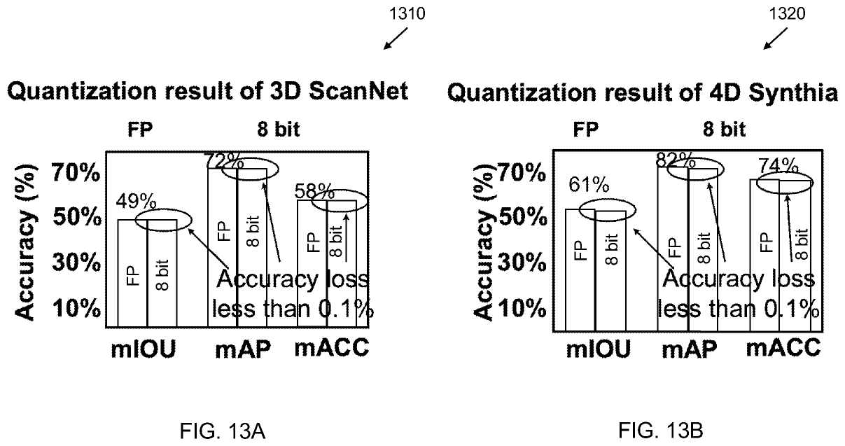

FIG. 13A shows a graph 1310 that illustrates the accuracy of this work on database SCANNET for 3D quantization with only 0.1% accuracy loss compared with FP results. FIG. 13B shows a graph 1320 that illustrates the accuracy of this work on database SYNTHIA for 4D quantization with only 0.1% accuracy loss compared with FP results. In comparison with conventional dense CNN, a speedup of 89.3× for 3D image or 270.1× for 4D image was achieved.

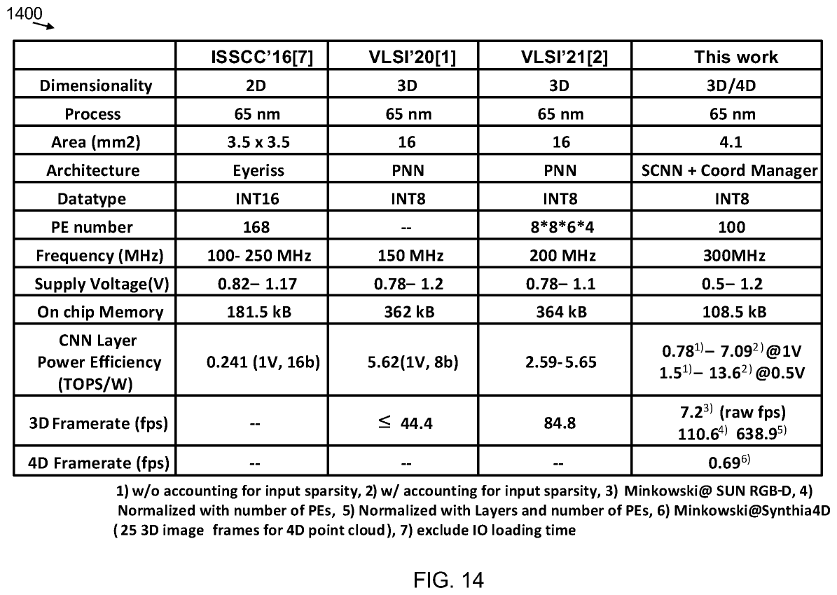

FIG. 14 is a table that shows comparisons of the measurements of the test chip 1000 with prior point-cloud works. This is the first sparse convolution accelerator targeting 3D/4D point-cloud image/videos. While the raw framerate of 7.2 fps is lower than [2] due to 5× larger CNN model size and 15× smaller PE array used in this work, a 7.5× higher framerate was achieved when normalized to similar model size and PE array due to the significant runtime reduction of sparse convolution. In addition, this is the only CNN accelerator that also handles 4D point-cloud videos.

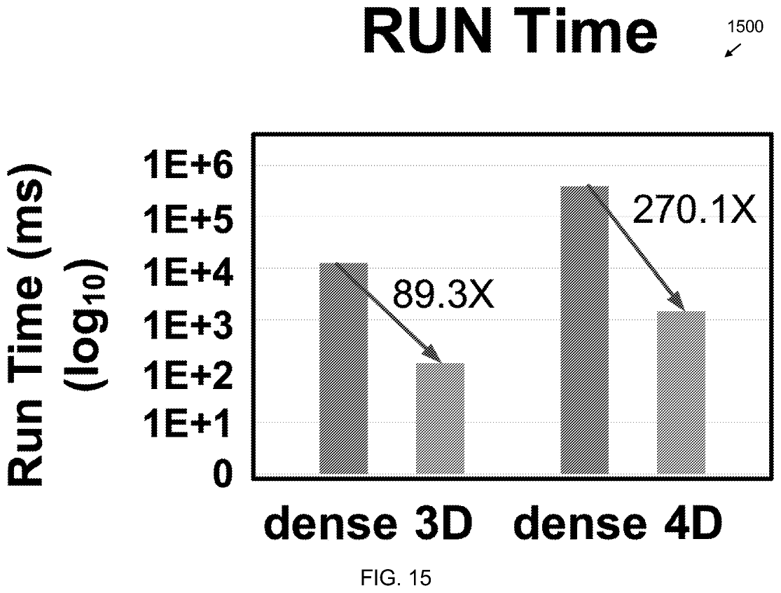

FIG. 15 is a graph 1500 that shows the run time reductions of the SCNN test chip 1000 compared to dense CNN examples for 3D point clouds and 4D point clouds.

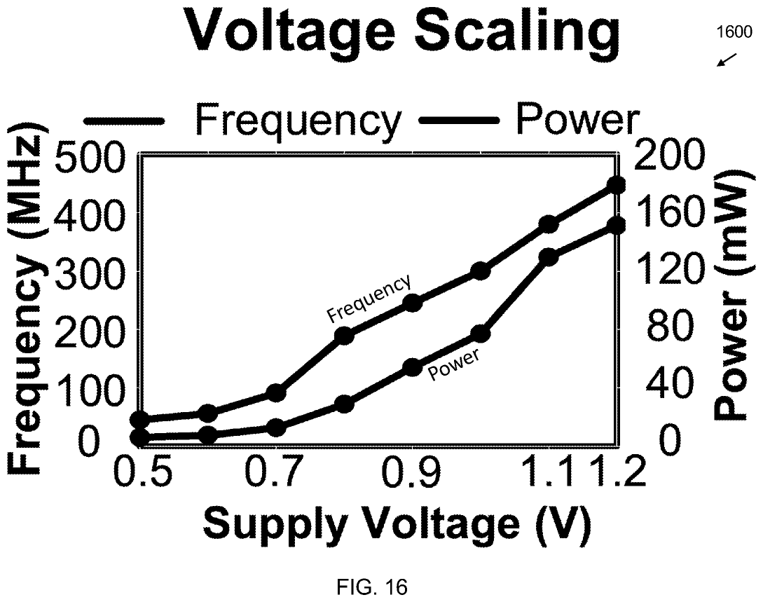

FIG. 16 is a graph 1600 that shows how voltage scaling from 0.5 V to 1.2 V affects both frequency and power.

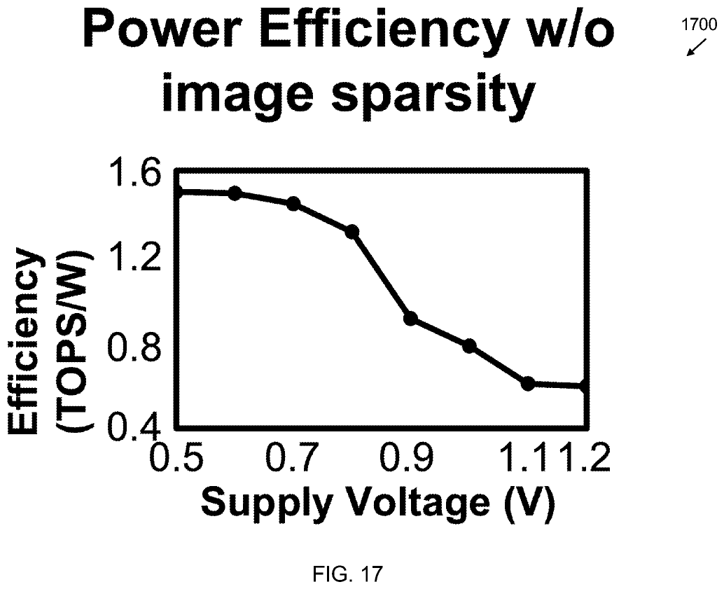

FIG. 17 is a graph 1700 that shows how voltage scaling from 0.5 V to 1.2 V affects power efficiency without image sparsity.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

The functions, acts or tasks illustrated in the Figures or described may be executed in a digital and/or analog domain and in response to one or more sets of logic or instructions stored in or on non-transitory computer readable medium or media or memory. The functions, acts or tasks are independent of the particular type of instructions set, storage media, processor or processing strategy and may be performed by software, hardware, integrated circuits, firmware, microcode and the like, operating alone or in combination. The memory may comprise a single device or multiple devices that may be disposed on one or more dedicated memory devices or disposed on a processor or other similar device. When functions, steps, etc. are said to be “responsive to” or occur “in response to” another function or step, etc., the functions or steps necessarily occur as a result of another function or step, etc. It is not sufficient that a function or act merely follow or occur subsequent to another. The term “substantially” or “about” encompasses a range that is largely (anywhere a range within or a discrete number within a range of ninety-five percent and one-hundred and five percent), but not necessarily wholly, that which is specified. It encompasses all but an insignificant amount.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A method for processing sparse point clouds using a sparse convolutional neural network (SCNN), the method comprising:
configuring a processing element (PE) array for performing multiply-accumulate (MAC) operations for coordinate management;
storing, in an input memory, a plurality of input sparse point cloud data including spatial coordinate data and an end address;
loading the plurality of input sparse point cloud data into the PE array;
storing the end address in an index memory;
loading multiple weights of different outputs for the same input into the index memory;
loading multiple weights from a kernel weight look-up table (LUT) into the PE array, the weights loaded based on an index value of the index memory, the index value shared by a plurality of output channels of the PE array; and
accumulating outputs of MAC operations by the PE array into output memory based on a target output address memory stored in the index memory.

2. The method of claim 1, further comprising:
configuring the PE array for performing sparse convolutional neural network processing;
storing in the input memory, by a processor, a plurality of input sparse point cloud data including pixel value data;
performing image segmentation using sparse convolution on the plurality of input sparse point cloud data including pixel value data in the PE array; and
outputting the image segmentation data based on the target output address memory stored in the index array.

3. The method of claim 1, further comprising:
calculating a distance, by the PE array, between a pair of coordinates of the input sparse point cloud data;
determining that the distance is less than a neighbor threshold distance; and
responsive to determining that the distance is less than the neighbor threshold distance, writing a relative position of the pair of coordinates into a rule book.

4. The method of claim 1, further comprising:
calculating a distance, by the PE array, between a respective position along one axis of each of a pair of coordinates of the input sparse point cloud data;
determining that the distance is greater than a neighbor threshold distance; and
responsive to determining that the distance is greater than the neighbor threshold distance, refraining from calculating further distances between respective positions along other axes of the pair of coordinates.

5. The method of claim 4, further comprising:
responsive to determining that the distance is greater than the neighbor threshold distance, refraining from writing relative position information of the pair of coordinates into the rule book.

6. The method of claim 1, further comprising:
dividing the input sparse point cloud into sub-space according to an octree data structure for searching;
searching for a pair of coordinates of the input sparse point cloud data within a sub-space block;
determining that one of the pair of coordinates being searched is within a different sub-space block; and
increasing a size of a sub-space block to encompass both of the pair of coordinates being searched.

7. The method of claim 1, further comprising:
dividing the input sparse point cloud into sub-space according to an octree data structure for searching;
searching for a pair of coordinates of the input sparse point cloud data within a sub-space block;
determining that the pair of coordinates being searched are too distant to be neighbors based on the search within the sub-space block; and
responsive to determining that the pair of coordinates being searched are too distant to be neighbors, discontinuing the search for the pair of coordinates in the input sparse point cloud.

8. A sparse convolutional neural network (SCNN) integrated circuit (IC) device for processing sparse point clouds, the device comprising:
an array of artificial neural network (ANN) processing elements (PEs), the array of ANN PEs being configurable into a first mode at a first time for performing multiply-accumulate (MAC) operations on sparse data inputs and kernel values, and configurable into a second mode at a second time for performing sparse convolution operations;
a sparse convolution unit;
a coordinate manager unit configured to build and manage a database of spatial relationships between sparse point cloud data points;
a non-transitory index memory;
a non-transitory weight look-up table (LUT);
a non-transitory output memory;
a controller for controlling operations performed by the SCNN IC device according to computing instructions stored in a non-transitory instruction memory;
a non-transitory instruction memory having stored thereon computing instructions, executable by the controller, to cause the SCNN IC to perform operations of a method for processing sparse point clouds, the method comprising:
configuring a processing element (PE) array for performing multiply-accumulate (MAC) operations for coordinate management;
storing, in an input memory, a plurality of input sparse point cloud data including spatial coordinate data and an end address;
loading the plurality of input sparse point cloud data into the PE array;
storing the end address in an index memory;
loading multiple weights of different outputs for the same input into the index memory;
loading multiple weights from a kernel weight look-up table (LUT) into the PE array, the weights loaded based on an index value of the index memory, the index value shared by a plurality of output channels of the PE array; and
accumulating outputs of MAC operations by the PE array into output memory based on a target output address memory stored in the index memory.

9. The SCNN IC device of claim 8, wherein the method further comprises:
configuring the PE array for performing sparse convolutional neural network processing;
storing, in the input memory, a plurality of input sparse point cloud data including pixel value data;
performing image segmentation using sparse convolution on the plurality of input sparse point cloud data including pixel value data in the PE array; and
outputting the image segmentation data based on the target output address memory stored in the index array.

10. The SCNN IC device of claim 8, wherein the method further comprises:
calculating a distance, by the PE array, between a pair of coordinates of the input sparse point cloud data;
determining that the distance is less than a neighbor threshold distance; and responsive to determining that the distance is less than the neighbor threshold distance, writing a relative position of the pair of coordinates into a rule book.

11. The SCNN IC device of claim 8, wherein the method further comprises:
calculating a distance, by the PE array, between a respective position along one axis of each of a pair of coordinates of the input sparse point cloud data;
determining that the distance is greater than a neighbor threshold distance; and
responsive to determining that the distance is greater than the neighbor threshold distance, refraining from calculating further distances between respective positions along other axes of the pair of coordinates.

12. The SCNN IC device of claim 11, wherein the method further comprises:
responsive to determining that the distance is greater than the neighbor threshold distance, refraining from writing relative position information of the pair of coordinates into the rule book.

13. The SCNN IC device of claim 8, wherein the method further comprises:
dividing the input sparse point cloud into sub-space according to an octree data structure for searching;
searching for a pair of coordinates of the input sparse point cloud data within a sub-space block;
determining that one of the pair of coordinates being searched is within a different sub-space block; and
increasing a size of a sub-space block to encompass both of the pair of coordinates being searched.

14. The SCNN IC device of claim 8, wherein the method further comprises:
dividing the input sparse point cloud into sub-space according to an octree data structure for searching;
searching for a pair of coordinates of the input sparse point cloud data within a sub-space block;
determining that the pair of coordinates being searched are too distant to be neighbors based on the search within the sub-space block; and
responsive to determining that the pair of coordinates being searched are too distant to be neighbors, discontinuing the search for the pair of coordinates in the input sparse point cloud.

15. A sparse convolutional neural network (SCNN) integrated circuit (IC) device for processing sparse point clouds, the device comprising electronic circuitry and processing elements configured to perform operations of a method comprising:
configuring a processing element (PE) array for performing multiply-accumulate (MAC) operations for coordinate management;
storing, in an input memory, a plurality of input sparse point cloud data including spatial coordinate data and an end address;
loading the plurality of input sparse point cloud data into the PE array;
storing the end address in an index memory;
loading multiple weights of different outputs for the same input into the index memory;
loading multiple weights from a kernel weight look-up table (LUT) into the PE array, the weights loaded based on an index value of the index memory, the index value shared by a plurality of output channels of the PE array; and
accumulating outputs of MAC operations by the PE array into output memory based on a target output address memory stored in the index memory.

16. The SCNN IC device of claim 15, wherein the method further comprises:
configuring the PE array for performing sparse convolutional neural network processing;
storing, in the input memory, a plurality of input sparse point cloud data including pixel value data;
performing image segmentation using sparse convolution on the plurality of input sparse point cloud data including pixel value data in the PE array; and
outputting the image segmentation data based on the target output address memory stored in the index array.

17. The SCNN IC device of claim 15, wherein the method further comprises:
calculating a distance, by the PE array, between a pair of coordinates of the input sparse point cloud data;
determining that the distance is less than a neighbor threshold distance; and
responsive to determining that the distance is less than the neighbor threshold distance, writing a relative position of the pair of coordinates into a rule book.

18. The SCNN IC device of claim 15, wherein the method further comprises:
calculating a distance, by the PE array, between a respective position along one axis of each of a pair of coordinates of the input sparse point cloud data;
determining that the distance is greater than a neighbor threshold distance; and
responsive to determining that the distance is greater than the neighbor threshold distance, refraining from calculating further distances between respective positions along other axes of the pair of coordinates.

19. The SCNN IC device of claim 15, wherein the method further comprises:
dividing the input sparse point cloud into sub-space according to an octree data structure for searching;
searching for a pair of coordinates of the input sparse point cloud data within a sub-space block;
determining that one of the pair of coordinates being searched is within a different sub-space block; and
increasing a size of a sub-space block to encompass both of the pair of coordinates being searched.

20. The SCNN IC device of claim 15, wherein the method further comprises:
dividing the input sparse point cloud into sub-space according to an octree data structure for searching;
searching for a pair of coordinates of the input sparse point cloud data within a sub-space block;
determining that the pair of coordinates being searched are too distant to be neighbors based on the search within the sub-space block; and
responsive to determining that the pair of coordinates being searched are too distant to be neighbors, discontinuing the search for the pair of coordinates in the input sparse point cloud.
